(19) United States
(12) Patent Application Publication
(10) Pub. No.: US 2019/0064028 A1
(43) Pub. Date: Feb. 28, 2019

(54) LEAK DETECTION SYSTEM AND LEAK DETECTION METHOD

(71) Applicant: Shanghai XPT Technology Limited, Shanghai City (CN)

(72) Inventors: Mu-Jen Huang, Taipei City (TW); Ya-Li Tai, Taoyuan City (TW); Tianle Chen, Shanghai City (CN)

(21) Appl. No.: 15/972,246

(22) Filed: May 7, 2018

(30) Foreign Application Priority Data
Aug. 23, 2017 (CN) 201710731965.1
Aug. 23, 2017 (CN) 201721061735.0

(51) Int. Cl. G01M 3/00; G06T 7/20; G01N 21/85

(52) U.S. Cl. CPC G01M 3/002; G01N 2021/8578; G01N 21/85; G06T 7/20

(57) ABSTRACT

A leak detection system, comprising a gas supplying device, configured to provide a tracer gas, wherein a temperature of the tracer gas is higher or lower than a temperature of ambient air; a gas pumping device, connected to the gas supplying device, configured to pump the tracer gas into a case; a gas exhausting device, configured to exhaust gas out of the case; a thermal image capturing device, configured to capture thermal images of the case; and a processing unit, electrically connected to the thermal image capturing device, configured to determine whether the tracer gas is leaking out of the case according to the thermal images of the case.

### BACKGROUND OF THE INVENTION

### 1. Field of the Invention

The present invention relates to a leak detection system and a leak detection method thereof, and more particularly, to a leak detection system and a leak detection method utilizing high temperature or low temperature gas for the leak detection process.

### 2. Description of the Prior Art

A conventional car motor assembly includes an inverter, a motor and a gearbox. The inverter transforms DC voltage from a battery to AC voltage, for driving the motor. The gearbox delivers power generated by the motor to other connected components for propelling the vehicle. The inverter, the motor and the gearbox are jointly connected inside an enclosed case. When the car motor assembly is running, the inverter, the motor and the gearbox generate heat. In order to maintain functionality and efficiency of the car motor assembly from degradation from heat, the conventional art utilizes cooling medium flowing through the car motor assembly to dissipate heat. However, if the inverter, the motor and the gearbox are not properly sealed and causing cooling medium leaks, cooling efficiency may reduce and further damaging functionality of the motor assembly and the vehicle. The prior art uses fluorescent agent while performing the leak detection process, which may damage the inverter, the motor and the gearbox. Therefore, the conventional leak detection system and method may not effectively and efficiently perform the leak detection process to the car motor assembly.

### SUMMARY OF THE INVENTION

The present invention provides a leak detection system and a leak detection method for effectively and efficiently performing the leak detection process to the motor car assembly.

The present invention provides a leak detection system, comprising a gas supplying device, configured to provide a tracer gas, wherein a temperature of the tracer gas is higher or lower than a temperature of ambient air; a gas pumping device, connected to the gas supplying device, configured to pump the tracer gas into a case; a gas exhausting device, configured to exhaust gas out of the case; a thermal image capturing device, configured to capture thermal images of the case; and a processing unit, electrically connected to the thermal image capturing device, configured to determine whether the tracer gas is leaking out of the case according to the thermal images of the case.

The present invention further provides a leak detection method, comprising a tracer gas, wherein a temperature of the tracer gas is higher or lower than a temperature of ambient air; providing a gas pumping device, configured to pump the tracer gas into a case; providing a gas exhausting device, configured to exhaust gas out of the case; capturing thermal images of the case; and determining whether the tracer gas is leaking out of the case according to the thermal images of the case.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a leak detection system according to an embodiment of the present invention.

FIG. 2 illustrates a leak detection system performing a leak detection to a car motor assembly according to one embodiment of the present invention.

FIG. 3 illustrates a flowchart of a leak detection method of the present invention.

### DETAILED DESCRIPTION

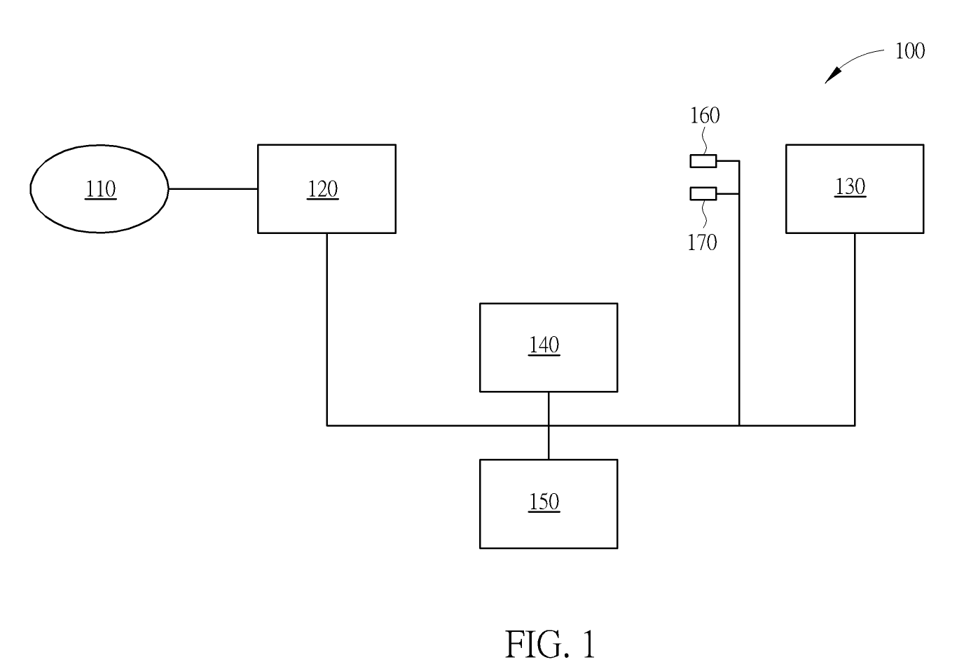

FIG. 1 is a schematic diagram of a leak detection system according to one embodiment of the present invention. As shown, the leak detection system 100 of the present invention may include a gas supplying device 110, a gas pumping device 120, a gas exhausting device 130, a thermal image capturing device 140 and a processing unit 150. The gas supplying device 110 provides a tracer gas, wherein a temperature of the tracer gas is higher or lower than a temperature of ambient air. For example, the tracer gas can be atmospheric air, easily obtained gas or non-corrosive gas (e.g. nitrogen or carbon dioxide). A temperature of the tracer gas may be a preset value higher or lower (e.g. 100° C.) than room temperature (e.g. 25° C.), and the present invention is not limited herein. A temperature difference between the tracer gas and ambient air may be varied based on specific detection scenarios. The gas pumping device 120 is connected to the gas supplying device 110, configured to pump the tracer gas into a testing object. The gas exhausting device 130 exhausts gas out of the testing object. The thermal image capturing device 140 captures thermal images of the testing object. The processing unit 150 is electrically connected to the thermal image capturing device 140, and determines whether the tracer gas is leaking out of the testing object and where the testing object leaks according to the thermal images of the testing object.

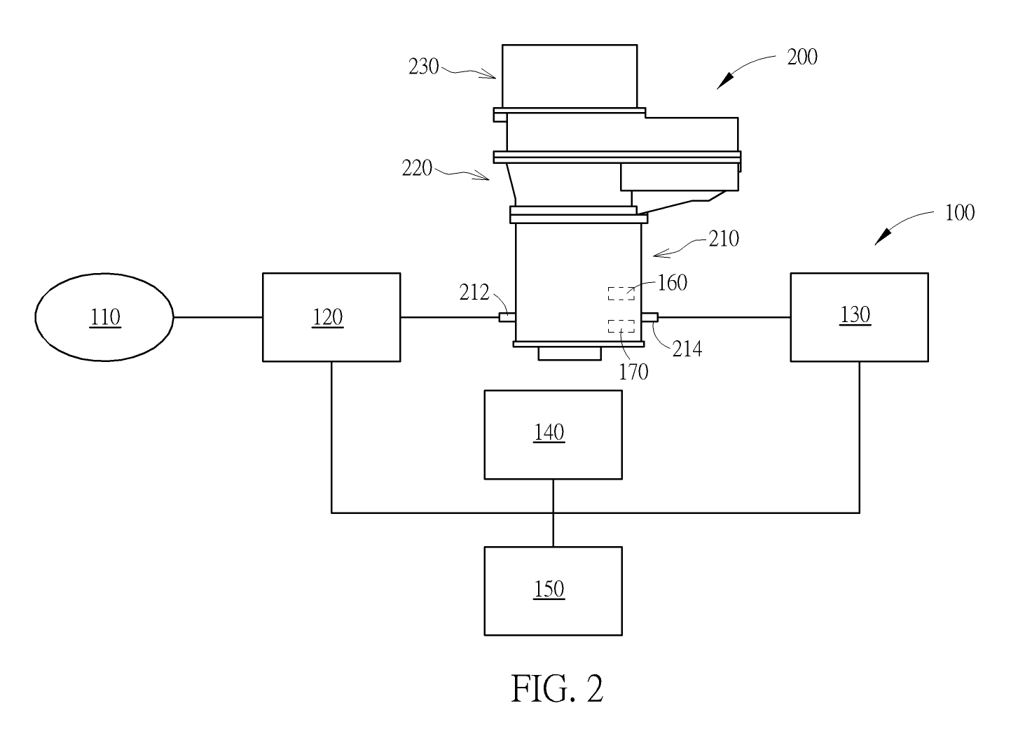

In one embodiment, FIG. 2 illustrates a leak detection system performing a leak detection process to a car motor assembly according to one embodiment of the present invention. As shown, the leak detection system 100 of the present invention performs the leak detection process to a car motor assembly 200. The car motor assembly 200 includes a motor 210, a gearbox 220 and an inverter 230. The cases of the motor 210, the gearbox 220 and the inverter 230 are jointly connected and therefore form an enclosed case. Moreover, the car motor assembly 200 includes an air inlet 212 and an air outlet 214. While performing the leak detection process, the gas pumping device 120 of the leak detection system 100 may connect to the air inlet 212, for pumping the tracer gas into the car motor assembly 200 through the air inlet 212; the gas exhausting device 130 of the leak detection system 100 may connect to the air outlet 214, for exhausting gas out of the car motor assembly 200 through the air outlet 214. Since the gas pumping device 120 and the gas exhausting device 130 of the leak detection system 100 may operate simultaneously, gas inside the car motor assembly 200 may be shortly replaced by the tracer gas. Furthermore, the processing unit 150 may control gas fluxes of the gas pumping device 120 and the gas exhausting device 130, for controlling a gas pressure of the tracer gas inside the car motor assembly 200 to be larger than a gas pressure of ambient air. After gas inside the car motor assembly 200 is replaced by the tracer gas, the thermal image capturing device 140 may further capture the thermal images of the car motor assembly 200. In the present invention, the amount of images arranged by the thermal image capturing device 140 is not limited to one image and may be varied with different positions according to specific detection scenarios. After the thermal images of the car motor assembly 200 are captured by the thermal image capturing device 140, the processing unit 150 may further determine whether the tracer gas is leaking out of the car motor assembly 200 according to the thermal images of the car motor assembly 200. For example, when the tracer gas is leaking out of the enclosed case of the car motor assembly 200, since the temperature of the tracer gas is a preset value higher or lower than the temperature of ambient air, the processing unit 150 may conclude where the tracer gas is leaking according to a high temperature zone or a low temperature zone shown in the thermal images of the car motor assembly 200.

According to descriptions above, the leak detection system 100 of the present invention takes atmospheric air, easily obtained gas or non-corrosive gas as the tracer gas, which cause no damage to the car motor assembly 200 and needs no further cleaning process after the leak detection. In addition, the leak detection system 100 of the present invention may simultaneously perform pumping and exhausting to the car motor assembly 200, which may shortly replace gas inside the car motor assembly 200 to the tracer gas and further improve efficiency of the leak detection process.

Moreover, the leak detection system 100 of the present invention may further include a gas pressure sensing unit 160, configured to sense a gas pressure inside the car motor assembly 200. The processing unit 150 may control the gas fluxes of the gas pumping device 120 and the gas exhausting device 130 according to a sensing result of the gas pressure sensing unit 160, for keeping the gas pressure inside the car motor assembly 200 to be fixed or within a preset range. In such an embodiment, the gas pressure sensing unit 160 is arranged next to the air outlet 214 of the car motor assembly 200, and the present invention is not limited herein. Since the leak detection system 100 may simultaneously perform pumping and exhausting to the car motor assembly 200, the gas pressure inside the car motor assembly 200 may be controlled more accurately and further prevent instability of the gas pressure inside the car motor assembly 200.

In another embodiment, the leak detection system 100 of the present invention may include a temperature sensing unit 170, configured to sense a gas temperature inside the car motor assembly 200. The processing unit 150 may control the gas fluxes of the gas pumping device 120 and the gas exhausting device 130 according to a sensing result of the temperature sensing unit 170, for keeping the gas temperature inside the car motor assembly 200 to be fixed or within a preset range. In such an embodiment, the temperature sensing unit 170 is arranged nearby the air outlet 214 of the car motor assembly 200, and the present invention is not limited herein. Since the leak detection system 100 of the present invention may simultaneously perform pumping and exhausting to the car motor assembly 200, the gas temperature inside the car motor assembly 200 may be controlled more accurately and further prevent instability of the gas temperature inside the car motor assembly 200.

In another aspect, when performing the leak detection process, the car motor assembly 200 may be placed under a subatmospheric pressure environment in which the tracer gas is more likely to leak out of the enclosed case of the car motor assembly 200, and further improves efficiency of the leak detection process of the present invention.

In the embodiments stated above, the leak detection system 100 of the present invention performs the leak detection process to the car motor assembly 200, and the present invention is not limited herein. The leak detection system 100 of the present invention may perform the leak detection process to a case or a structure of other devices.

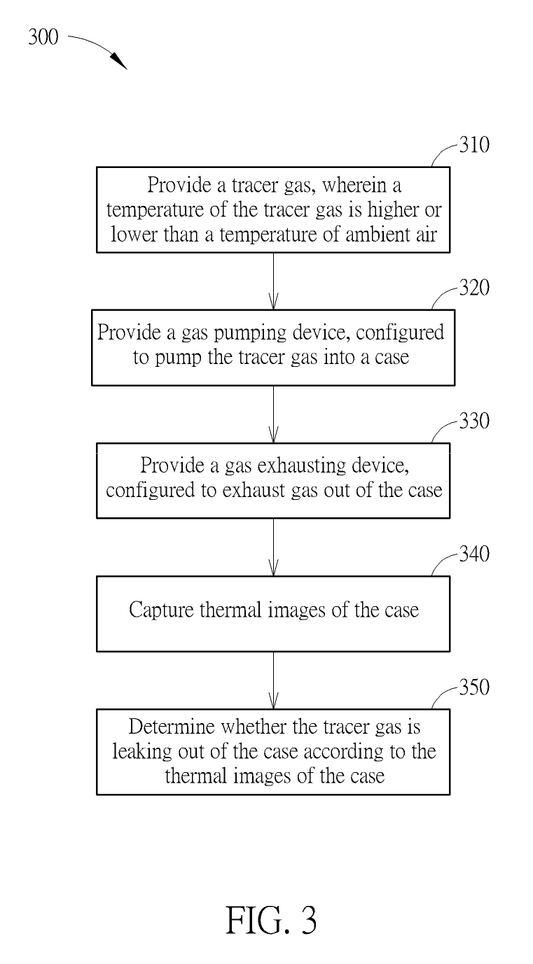

FIG. 3 is a flowchart 300 of a leak detection method in accordance with the present invention. The flowchart 300 includes the following process:

Step 310: Provide a tracer gas, wherein a temperature of the tracer gas is higher or lower than a temperature of ambient air.

Step 320: Provide a gas pumping device, configured to pump the tracer gas into a case.

Step 330: Provide a gas exhausting device, configured to exhaust gas out of the case.

Step 340: Capture thermal images of the case.

Step 350: Determine whether the tracer gas is leaking out of the case according to the thermal images of the case.

The leak detection system and the leak detection method thereof described herein are capable of performing the leak detection process with high temperature or low temperature gas, which cause no damage to the testing object and needs no further cleaning process after the leak detection process. In addition, the leak detection system may simultaneously perform pumping and exhausting to the case of the testing object, for shortly replacing air inside the case to the tracer gas with accurate control of the gas pressure and the gas temperature inside the case. Therefore, the leak detection system and the leak detection method of the present invention are advantageous over the conventional art for better efficiency of the leak detection process and higher accuracy of gas controlling.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A leak detection system, comprising:
a gas supplying device, configured to provide a tracer gas, wherein a temperature of the tracer gas is higher or lower than a temperature of ambient air;
a gas pumping device, connected to the gas supplying device, configured to pump the tracer gas into a case;
a gas exhausting device, configured to exhaust gas out of the case;
a thermal image capturing device, configured to capture thermal images of the case; and
a processing unit, electrically connected to the thermal image capturing device, configured to determine whether the tracer gas is leaking out of the case according to the thermal images of the case.

2. The leak detection system of claim 1, wherein a gas pressure of the tracer gas inside the case is greater than a gas pressure of ambient air.

3. The leak detection system of claim 1, further comprising a gas pressure sensing unit, configured to sense a gas pressure inside the case, wherein the processing unit is further configured to control gas fluxes of the gas pumping device and the gas exhausting device according to a sensing result sensed by the gas pressure sensing unit.

4. The leak detection system of claim 3, wherein the processing unit controls the gas fluxes of the gas pumping device and the gas exhausting device according to the sensing result sensed by the gas pressure sensing unit, for stabilizing the gas pressure inside the case.

5. The leak detection system of claim 1, further comprising a temperature sensing unit, configured to sense a gas temperature inside the case, wherein the processing unit is further configured to control gas fluxes of the gas pumping device and the gas exhausting device according to a sensing result sensed by the temperature sensing unit.

6. The leak detection system of claim 5, wherein the processing unit controls the gas fluxes of the gas pumping device and the gas exhausting device according to the sensing result sensed by the temperature sensing unit, for stabilizing the gas temperature inside the case.

7. The leak detection system of claim 1, wherein the case is placed under a subatmospheric pressure environment.

8. A leak detection method, comprising:
providing a tracer gas, wherein a temperature of the tracer gas is higher or lower than a temperature of ambient air;
providing a gas pumping device, configured to pump the tracer gas into a case;
providing a gas exhausting device, configured to exhaust gas out of the case;
capturing thermal images of the case; and
determining whether the tracer gas is leaking out of the case according to the thermal images of the case.

9. The leak detection method of claim 8, wherein a pressure of the tracer gas inside the case is greater than a gas pressure of ambient air.

10. The leak detection method of claim 8, further comprising:
providing a gas pressure sensing unit, configured to sense a gas pressure inside the case; and
controlling gas fluxes of the gas pumping device and the gas exhausting device according to a sensing result sensed by the gas pressure sensing unit.

11. The leak detection method of claim 10, wherein the step of controlling the gas fluxes of the gas pumping device and the gas exhausting device according to the sensing result sensed by the gas pressure sensing unit is stabilizing the gas pressure inside the case.

12. The leak detection method of claim 8, further comprising:
providing a temperature sensing unit, configured to sense a gas temperature inside the case; and
controlling the gas fluxes of the gas pumping device and the gas exhausting device according to a sensing result sensed by the temperature sensing unit.

13. The leak detection method of claim 12, wherein the step of controlling the gas fluxes of the gas pumping device and the gas exhausting device according to the sensing result sensed by the temperature sensing unit is stabilizing the gas temperature inside the case.

14. The leak detection method of claim 8, wherein the case is placed under a subatmospheric pressure environment.
